(19) United States
(12) Patent Application Publication
(10) Pub. No.: US 2009/0213144 A1
(43) Pub. Date: Aug. 27, 2009

(54) APPARATUS AND METHOD TO CALCULATE RASTER DATA

(76) Inventors: Tor Dokken, Oslo (NO); Trond Runar Hagen, Oslo (NO); Johan Simon Seland, Oslo (NO)

Correspondence Address: WENDEROTH, LIND & PONACK, L.L.P., 1030 15th Street, N.W.,, Suite 400 East, Washington, DC, 20005-1503, US

(21) Appl. No.: 12/308,219

(22) PCT Filed: Jun. 7, 2007
(86) PCT No.: PCT/NO2007/000196

§ 371 Date: Mar. 31, 2009

(30) Foreign Application Priority Data
Jun. 13, 2006 (NO) 20062770

(51) Int. Cl. G09G 5/00

(52) U.S. Cl. 345/660

(57) ABSTRACT

A computer apparatus is disclosed for determining high quality raster data generation of scalar fields or vector fields, represented by piecewise polynomials or piecewise rational functions. It comprise one or more CPUs operative to do portions of the raster data generation algorithm, initializing sub-algorithms thereof, control the sub-algorithms, and possibly read back the generated raster data or transfer the raster data to other processors in the system. The computer apparatus further comprises one or more stream processing units operative to receive parts of the raster data algorithm from the CPUs and to execute sub-algorithms of the raster data algorithm, resulting in raster data that can be directly visualized, read back to the CPU or transferred to other processors.

### FIELD OF INVENTION

The invention relates generally to a computer apparatus and a data processing method and apparatus for the calculation of raster data from scalar fields and vector fields for the purpose of building an explicit representation of levels of the one or more fields or for visualizing the one or more fields using iso-surface and/or volume visualization methods. One specialization of the invention is the visualization of piecewise algebraic hypersurfaces. More particularly, the invention relates to a computer apparatus and data processing method which may be employed with advantage within computer aided design, computer aided manufacturing, rapid prototyping, algebraic geometry, finite element pre-processing, finite element post processing, computer animation, interpretation and visualization of medical data, and interpretation and visualization of petroleum related data where fast and topologically correct and geometrically accurate raster data is needed. The apparatus combines one or more CPUs with one or more SPUs (Stream Processing Units), with one embodiment of the SPUs being one or more Graphics Processing Unit (GPUs).

### DESCRIPTION OF RELATED ART

Raster data is information stored in a d-dimensional grid of cells, where d is often in the range of 1 to 4. Each cell is indexed by d discrete numbers from some finite range. All the cells contain the same number and types of information elements. A cell can contain different information element types. Raster data is popular in such fields as computer vision, image processing, and computer graphics where they are commonly used to represent images (2D raster grids), videos and MRI volumes (3D raster grids), etc. In this invention the element types used can have any interpretation. However, often they will represent point locations, gradients, intensity values, shading data, RGB values, values of the field integrated over sub-sets such as sub-volumes or line segments.

In computer graphics 3D visualization is based on making an image of an object using either perspective or parallel projection. In this process the part of space that is to be viewed is defined by a volume V, and through projections and transformations the object is mapped into standard viewing coordinates. The transformations can be found in computer graphics text books, and are not important when describing the principles of this invention.

In traditional ray tracing, the visualization is based on tracing rays starting in the eye point (centre of projection) and going through the pixels of the image to be produced. Then the first intersection of the ray with the scene visualized is calculated. Dependent of the properties of the object hit, e.g. transparency, refraction or reflection, further searching is done along the ray, or along the reflection ray. The focus of our invention is only related to what happens inside the volume V.

Within visualization of 3D data and time varying 3D data, visualization traditionally has been based on either triangulation of the geometry e.g. by the “marching cubes”-technique, or by ray tracing. Traditionally such algorithms have been run on the CPU (Central Processor Unit). However, the publication “The Ray Engine”, Graphics Hardware 2002, Sep. 1-2, 2002, Saarbrücken, Germany, The Eurographics Association, 2002, by Mathan A Carr et al, disclose a computer system for ray tracing of triangulations by using the GPU (Graphics card) as a computational resource. However, this is based on the intersection of triangles and the ray and not a segment of the ray and a scalar field as in the invention we present.

The PCT patent application PCT/NO 2005/000453 addresses a computer apparatus combining one or more CPUs with one or more SPUs (Stream Processing Units) for finding the topology and a geometric description of the intersection calculations of geometric objects and for detecting self-intersections in geometric objects. The computer apparatus proposed in the proposed invention addresses the generation of raster data, aimed at visualization or object segmentation and consequently addresses a different application area. Some of the similar mathematical approaches are used in both inventions; however, these are general in nature.

One typical example of a prior art scalar field visualization is ray tracing of level sets. Here each ray is traced from the centre of projection, through the pixel to be generated until a point in the scalar field possibly is identified with the specified scalar field level value. In the case when reflection or refraction is of interest the search is continued along the refracted ray and along the reflected ray until no more points are hit (inducing refraction and reflection) or the maximal level of recursion (number of reflections or refractions). One implementation of such an approach is described in the paper “Anders Adamson, Marc Alexa, Andrew Nealen. Adaptive Sampling of Intersectable Models Exploiting Image and Object-space Coherence” presented at the Third Eurographics Symposium on Geometry Processing, Jul. 4-6, 2005. However, in this approach the ray surface intersection is only performed on the CPU, not on the SPU (GPU) as proposed in the present invention.

Another examples is “marching cubes”, where for each cell in a volume grid, a triangulation of the iso-surfaces inside the cell is directly generated from the values in the eight corners of the cell and predefined rules on the topology of the triangulation based on the sign of the field values in the corners. The triangles generated by marching cubes can be viewed as a crude approximation to a tri-linear interpolation of the corners of the grid cell.

A related invention is disclosed in US-patent application 2004/008532 A1 as a system and method for modelling of graphical shapes, where the system comprises a central processing unit, a main processor and a graphics processor and where the calculations of the models and transformation calculations are done in the central processing unit which contains a first and a second vector processor and where the calculated data are sent to the graphics processor for rendering an later displaying on a display means.

U.S. Pat. No. 657,571 B1 describes an image system comprising a number of graphics processors, each activating their own processes based on instructions received from an external host computer and sending subsequently data to a rendering apparatus.

### SUMMARY OF INVENTION

Briefly, and in general terms, the present invention provides improvements in creating raster data from scalar or vector fields and an apparatus whereby data processing speed and raster data quality increase substantially.

More particularly, by way of example and not necessarily by way of limitation, the present invention provides an organization of the scalar or vector field processing to be performed on at least one CPU for controlling the process, and at least on stream processor or SPU for execution of computer intensive task of the scalar field or vector field processing.

When the raster data is generated as part of a visualization process the data processing speed and visual quality increase substantially and will be within pixel accuracy. This is especially important for scalar or vector field singularities, points where the field gradient vanishes, as the level set topology change around singularities. If sub-pixel accuracy is used when generating the raster data, then improved image quality can be achieve through anti-aliasing techniques.

When the raster data is generated as part of a segmentation process the data processing speed increase substantially and the level set topology generated will be correct within the geometric distance between the elements of the raster data.

Hence, the present invention satisfies a long existing need for enhanced generation of raster data from scalar fields and vector fields.

Hence, in a first aspect of the present invention, there is provided a computer apparatus for determining high quality raster data generation of fixed and time varying scalar fields or vector fields, represented by piecewise polynomials or piecewise rational functions. The computer apparatus comprises at least one central processor (CPU) operative to do portions of the raster data generation algorithm, initializing sub-algorithms thereof, control the sub-algorithms, and possibly read back the generated raster data or transfer the raster data to other processors in the system. The computer apparatus further comprises at least on stream processing unit (SPU) operative to receive parts of the raster data algorithm from the at least one CPU and to execute sub-algorithms of the raster data algorithm, resulting in raster data that can be directly visualized, read back to the one or more CPUs or transferred to other processors.

In another aspect of the present invention is a method to create at least one set of raster data from a time varying or constant scalar field or vector field within a volume. Said scalar or vector field is described using any of polynomial, rational, piecewise polynomial and piecewise rational representation. The method comprises at least controlling execution of a raster data algorithm, initializing subalgorithms thereof, controlling said sub-algorithms and controlling the use of the results of the calculations involving said sub-algorithms. The method is characterized by controlling at least one stream processor unit (SPU) operative to receive sub-algorithms of said raster data algorithm and to execute said sub-algorithms of said raster data algorithm, resulting in raster data.

A detailed definition of the present invention is given by the attached claim set.

### BRIEF DESCRIPTION OF THE DRAWINGS

The invention will be described in detail below taking reference to the attached drawings where:

FIG. 1 shows how the scalar field is intersected by ray segments defined by the centre of projection and the pixels to be calculated in the projection plane. The volume V can have any shape e.g. be a sphere.
101—f(x, y, z)=c, the level set to be sampled.
102—the centre of projection. For the parallel projection the centre of projection is moved to −≈ (minus infinity) along the ray.
103—the projection plane with n×m pixels to be rendered.
104—the volume V delimiting the part of scalar field addressed.
105—Ray from the centre of projection through a pixel in the projection plane. The ray is to be intersected with the iso-surface f(x, y, z)=c inside the delimiting volume V.

FIG. 2 shows the section through a line of pixels in the image plane. The level set to be drawn is defined by the curves (210). The part of the level set to be drawn is defined by the section through the volume V. Note that the volume do not have to be rectangular in shape, any volume shape can be used, e.g. a sphere. This volume is not the clipping volume of computer graphics.
203—a section through the rectangle in the projection plane with n pixels to be rendered.
204—a section through volume V delimiting the part of scalar field addressed. Only the level set inside here is to be sampled.
210—sections through level set f(x, y, z)=c to be sampled.
216—closest point on the ray within the volume V with level set value f=c.

FIG. 3 shows the behaviour of the level set along the ray. We are only interested in points on the ray having scalar field value f=c that are within the interval (315) defined by the volume V. For sampling and visualization we will in general be interested in the point closest to the centre of projection, but for other applications e.g. segmentation all points with f=c within the volume can be of interest. For the parallel projection the centre of projection is moved to −≈ (minus infinity) along the ray.
302 centre of projection, and start point of ray,
312 axis along which the distance from the centre of projection along the ray is measured,
313 value of level set f along ray,
314 axis along which the value of level set f is measured,
315 interval defined by the volume V along the ray where we search for level value c of f(x, y, z),
316 closest point on the ray within the volume V with level set value f=c.

FIG. 4 shows the approach used for sampling of the level set of a scalar field with parallel projections from 3 directions. Each direction only accepts points with surface normals with direction within the associated direction pyramid. For each view direction, multiple points can be stored. With the imposed condition on sampling direction, neighbouring points in each view direction will belong to the same topological branch of the level set surface. Different branches will be in disjoint regions. Points will be sampled fairly uniformly over the total level set surface.

401—first projection plane,
402—second projection plane,
403—third projection plane,
411—pyramid defining gradient directions of points to be recorded in first projection plane,
412—pyramid defining gradient directions of points to be recorded in second projection plane,
413—pyramid defining gradient directions of points to be recorded in third projection plane.

### DETAILED DESCRIPTION

The invention addresses scalar fields and vector fields that are either constant in time or vary with time. However, as the invention relates to discrete time steps in time varying fields, the time component is not included in the detailed descriptions to simplify the presentation. When addressing the time varying fields the following description relates to a specific time step.

Although the invention is not limited to scalar fields or vector fields, we will describe the mathematics involved in terms of scalar fields in R³. A vector field can be described by one scalar field for each component of the vector field.

A scalar field is a function f from Rⁿ to R, or a function f from Rⁿ to C (the complex numbers). That is, it is a function defined on the n-dimensional Euclidean space with real values. Often it is required to be continuous, or one or more times differentiable, that is, a function of class C^{k}, k≧0. The scalar field can be visualized as an n-dimensional space with a real or complex number attached to each point in the space. The derivative of a scalar field results in a vector field called the gradient field.

A vector field is a function f from Rⁿ to R^{m}, or a function f from Rⁿ to C^{m}. A vector field can consequently be described by one scalar field for each component of the vector field. Consequently the discussion following also covers vector fields.

A trimmed scalar field or vector field is a scalar of vector field where the part of Rⁿ addressed is defined by a number of other scalar fields tᵢ(x), i=, . . . , M. The only part of the scalar field or vector field we address are described by points satisfying tᵢ(x)≧0, i=, . . . , M, or alternatively tᵢ(x)≦0, i=M.

The scalar fields we will look into are described by piecewise polynomial functions or rational functions with numerator and denominator being piecewise polynomial functions, e.g., a tensor product B-spline function or NURBS-function, or a structure of polynomial or rational functions, each described over a volume. Frequently this volume will be a simplex (a tetrahedron in R³) with a chosen order of continuity between the pieces. However, the volume is not limited to being a simplex. Other relevant volumes are finite elements used for solution of partial differential equations by the Finite Element Method.

One aspect of mathematics of the invention is related to calculations for each polynomial piece in the description of the scalar field and thus we will concentrate in the following on each polynomial piece. The part of the scalar field we are interested in is described by a volume V, e.g., a rectangular box, sphere or a tetrahedron or any volumetric shape, often the volume will have a convex shape. If the volume is non-convex the volume can be subdivided into convex sub-volumes, and the method applied to each convex sub-volume. It should be noted that the volume V is not the same as the volumes used for the description of the structure of piecewise polynomial functions.

When addressing iso-surfaces the invention combines ideas from the two approaches by:
Looking at one cell or sub-volume at the time
Find within the cell or sub-volume the point on the specified iso-surface closest to the centre of projection.

However, the approach is not limited to only looking at the closest iso-surface within the cell or sub-volume. Other variants of the invention are to:
Look for the “n-th” iso-surface within the cell or sub-volume, with n≧1.
Look for multiple iso-surfaces with different levels simultaneously.
Integrating functions based on the properties or value of the scalar field along the view direction to generate a volume rendered image of the scalar field, possibly combined with iso-surface visualization.

In the case that we just have one cell or volume and look for values of f, with f(x, y, z)=0, we have a real algebraic surface. Consequently in addition to address scalar fields the invention addresses also sampling and visualization of real algebraic surfaces.

One preferred selection for implementation is a standard PC having one or more single- or multi-core CPUs running e.g. Windows, Linux or other operating systems with one or more stream type processors, preferably of GPU-type but not restricted to GPUs. Another selected implementation is a closer integrated CPUs and stream processors such as in the CELL-processor, consequently not limiting the stream processor to be integrated into a graphics card. The approach can also be implemented on battery powered PDA-type devices such as mobile phones that combine a CPU and programmable 3D graphics acceleration.

### Sampling of Level Set Points by Line Intersection

The simplest implementation of the approach, see FIGS. 1, 2 and 3, is by using a sampling unit, which is a program running on a processor that samples values or vector data from respectively a scalar or vector field at a given location in space. In case the field is varying in time also the moment in time is specified. The sampling unit works as follows:
Given a scalar field described by a polynomial function (x, y, z)
Given a 3D volume V (104) defining the part of the scalar field we want to address
Given a level set c of the scalar field we want to sample f(x, y, z)=c (101)
Given a projection plane and n×m points in a rectangular region of the projection plane (103)
Given a perspective or parallel projection (102). For the parallel projection the centre of projection is moved to −≈ (minus infinity) along the ray
For each of the n×m points in the rectangle make an infinite straight line (105) to describe all points that the given perspective or parallel projection maps on to the point
For each of the n×m points, intersect the infinite straight line (105, 312) with the iso-surface (210) and select the point (216, 316) inside the volume V (104, 204, 315) closest to the centre of projection in the volume. This computational expensive operation is run on the SPU.

The points found can both be represented as a point on the straight line (105, 312) by just remembering the parameter value of the point on the line, or be represented as a 3D point. Which information is stored depends on the later intended use of the raster data.

### Use of the Approach for Scalar Field Level Set Visualization

Visualization of level sets of scalar and vector fields is frequently used within medicine, oil & gas industry and for the interpretation of simulation results. As the above approach uses the same concepts as used in 3D computer graphics it is straight forward to use it for visualization of level sets of scalar or vector fields. We just have to make sure that the n×m points in the rectangular domain correspond to the resolution of the image we want to generate. Doing this we ensure pixel, or sub-pixel accurate visualization of the scalar field. For iso surface visualization purposes the following steps have to be added in the process.
Calculate the surface normal of each selected iso-surface point; this can be done on the SPU.
For each of the n×m points where an iso-surface point is found, use the reflection properties, color, transparency, and normal vector to calculate the correct coloring of the grid point, can be done on the SPU.

In the case where the SPU is an integrated part of the visualization pipeline as in the case of a GPU there is a direct connection to the displays used.

### Guaranteeing the Quality of the Point Sample

With the approach proposed above the quality of the points generated can be described as within pixel resolution when viewing from the used centre of projection. If there are isolated singularities in the set, e.g. where different braches meet the sampling seldom hits exactly on the singularity but the visual image generated will reflect the behavior of the region around the singularity and thus the singularity is indirectly represented. Zooming in the points will get closer and closer to the singularity and consequently the visual impression will be correct. By changing the constant defining the level set addressed a good visual impression of the scalar field can be produced. To guarantee that singularities are not missed, the analysis of the line segments intersecting the field can be replaced by analysis of the intersection of the field by long thin swept rectangles around each line segment. The swept rectangle of each line segment should just touch the swept rectangle of adjacent straight line segments to ensure that no gaps are left.

### Use of the Approach for Sampling of Level Sets of Scalar Fields

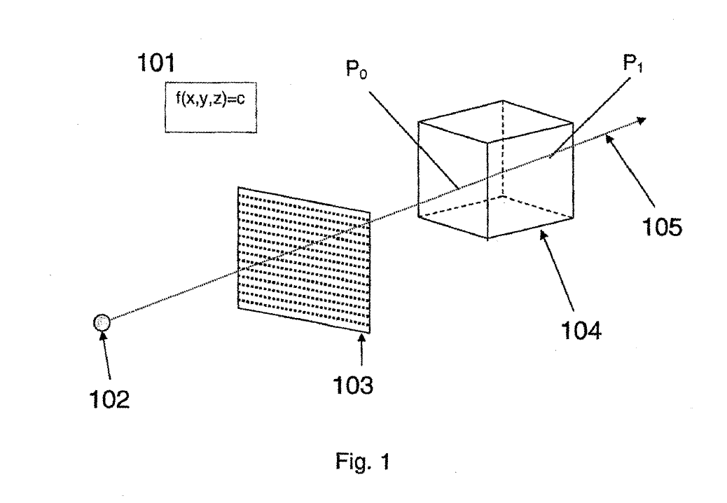

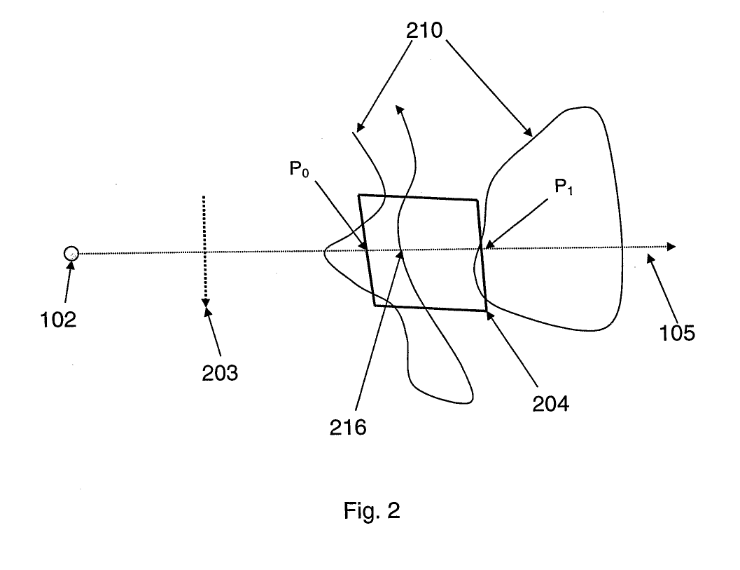

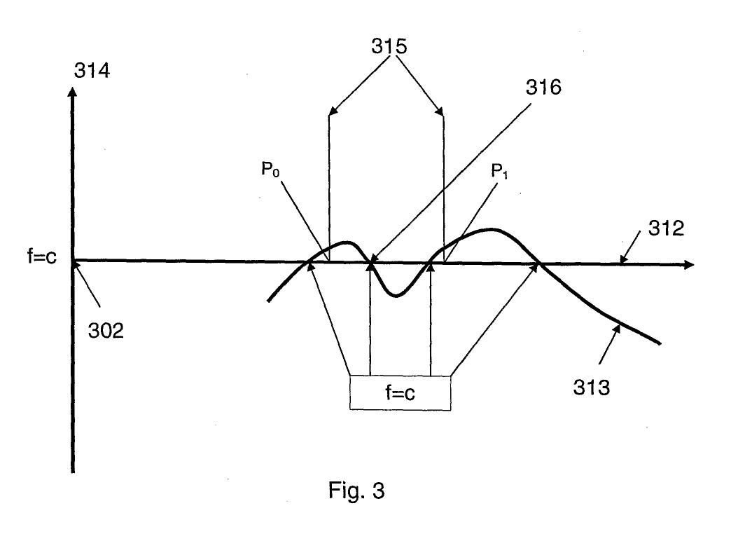

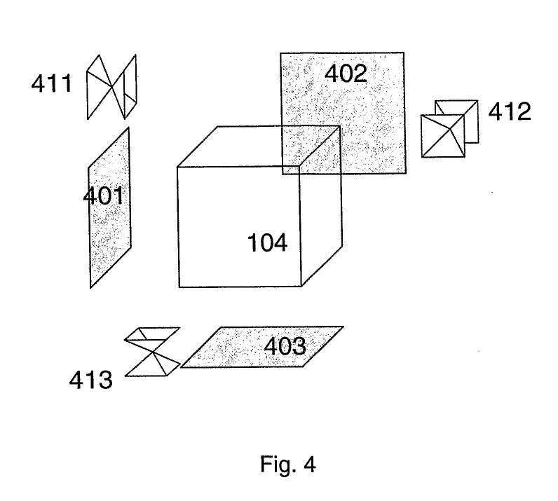

By sampling the level set from 3 different directions, FIG. 4 (401, 402, 403) a dense set of points can be found over the scalar field provided all intersection points within the volume are stored for all 3 projection directions, possibly also the gradient at each point is stored. However, these data sets will be overlapping and stitching of the data sets will be necessary.

However, if we control which points are sampled in the different projections by restricting the gradient of the scalar field to be within regular pyramids assigned to each projection as shown if FIG. 4 (411, 412, 413), there will be minimal overlap of the point sets generated.

Except where the branches of the normal field penetrate the volume V, the boundary of each disjoint data set will have to be merged with the boundary of disjoint data sets from the other projections. This merging operation will typically be performed on the CPUs.

Alternatively, no removal of points is done based on gradient direction, as this removal can be performed later in the process. In this case there will be overlapping of points sets generated in the different sampling planes.

### Mathematics of the Intersection of the Volume V, the Levels Set of the Scalar Field and the Ray.

The intersection of the ray and the volume V will trim the ray to a straight line segment between a point P₀ and a point P₁ with P₀ closer to the centre of projection than P₁, see FIG. 1 (104), FIG. 2 (204) and FIG. 3 (315). We will represent the straight line between the two points as a parametric curve l(t)=(1−t)P₀+t P₁, tε[0,1]. The scalar field is represented by either a tri-variate polynomial qₘ(x, y, z) of total degree

$$m , {q}_{m} ( x , y , z ) = {\sum }_{0 \leq i + j + k \leq m} {c}_{i , j , k} {x}^{i} {y}^{j} {z}^{k} ,$$

or as a tensor product tri-variate polynomial of bi-degrees (n₁, n₂, n₃) and total degree

$$\begin{matrix}m = {n}_{1} + {n}_{2} + {n}_{3} : {q}_{{n}_{1} , {n}_{2} , {n}_{3}} ( x , y , z ) \\ = {{\sum }_{i = 0}}^{{n}_{1}} {\sum }_{j = 0}^{{n}_{2}} {\sum }_{k = 0}^{{n}_{3}} {c}_{i , j , k} {x}^{i} {y}^{j} {z}^{k} .\end{matrix}$$

The intersection of i(t) and qₘ(x, y, z), can be expressed as qₘ(l(t))=0, where qₘ(l(t)) is a polynomial of degree m in t. Consequently the points we are looking for are zeroes of qₘ(l(t)) in the interval [0,1]. The intersection of l(t) and qₘ_{₁}_{, m}_{₂}_{, m}_{₃}(x, y, Z) can in the same way be expressed qₘ_{₁}_{, m}_{₂}_{, m}_{₃}(l(t))=0, with qₘ_{₁}_{, m}_{₂}_{, m}_{₃}(l(t)) in the general case a polynomial of degree m=n₁+n₂+n₃ in t.

Two central tasks to be performed for calculating the points we are looking for are thus:

An efficient and numerical stable method for finding either the polynomial ƒ(t)=qₘ(l(t)) or , with respective degree m or degree n₁+n₂+n₃.
An efficient algorithm to be run on the SPU for finding the zeroes of ƒ(t)=0 in the interval [0,1].

It should be noted that we do not need to find all the zeroes of ƒ(t)=0 in the interval [0,1] if we are just looking for the zero closest to the centre of projection.

### Finding the Polynomial ƒ(t) of Degree m

Dependent of the polynomial basis used for describing the scalar field different algorithms can be used for finding ƒ(t). We will now denote the scalar field q(x, y, z) and assume that it has total degree m.
If the scalar field is represented in a power basis then it is straight forward by insertion of l(t) into q(x, y, z) to find the analytical expression for ƒ(t). However, the power basis is not a good choice of polynomial basis, and should consequently be avoided.
If the scalar field is represented with a tri-variate tensor product Bernstein basis or a tri-variate tensor product B-spline basis, Blossoming known from spline theory is a good choice for making the analytical expression for ƒ(t) expressed in a Bernstein basis, or in a B-spline basis. In the case the scalar field is represented in a B-spline basis the resulting function ƒ(t) will be a piecewise polynomial expressed in a B-spline basis.
If the scalar field is represented as a Bernstein polynomial defined over a tetrahedron the Blossoming will provide algorithms for finding the analytical expressions of ƒ(t) represented in a Bernstein basis.

One implementation is to let program components running on the one or more CPUs use Blossoming to generate the analytical expression of f(t), and let the one or more CPUs use these analytical expression for generating program segments to be run on the one or more SPUs.

Finding the Zero of ƒ(t) when Using the Bernstein Basis.

The univariate function ƒ(t) expressed in a Bernstein basis looks like

$$f ( t ) = {\sum }_{i = 0}^{m} {c}_{i} ( \begin{matrix}m \\ i\end{matrix} ) {( 1 - t )}^{m - {i}_{t} i} , i = [ 0 , 1 ] .$$

We have translated the parameter interval of the polynomial to [0,1] to simplify the description. The Bernstein representation of the polynomial has a number of nice properties:
The curve in the interval [0,1] is a convex combination of the coefficients cᵢ, i=0, . . . , m. consequently if all c, are either positive or negative no zero exists in the interval[0,1].
ƒ(0)=c₀ and ƒ(1)=cmₘ. Thus if c₀=0 then ƒ(0)=0, and if cₘ=0 then ƒ(1)=0.
The number of internal zeroes in the interval [0,1] is less than or equal to the number of sign changes in the sequence f{cᵢ}ᵢ₌₀^{m}.

By subdividing the function into sub-pieces represented in the Bernstein basis, all zeroes in the interval [0,1] can be efficiently determined. Following the first introduction of algorithms for finding zeros of Bernstein basis represented polynomials many different formulation of these algorithms have been published. As a central part of the proposed approach is the use of a stream processor for finding such zeroes, the actual implementation has to be adapted to the specificities of stream processors and the actual performance characteristics of the stream processor used.

When implementing the approach on a programmable graphics card the functionality of the card will be used to map the geometry into standard viewport coordinates. The n×m points in a rectangular region is mapped onto the viewport, and n×m points correspond to the viewport resolution. The intersection of the ray and the 3D box is performed before the intersection of the ray and the iso-surface. Thus we can reduce the intersection of an infinite straight line and the iso-surface, to the intersection of a parametric described straight line segment and the isosurface.

### Representation of Scalar Fields and Conversion

A 3D scalar field can be represented in many ways.
By a polynomial in the power basis

$${q}_{m} ( x , y , z ) = {\sum }_{0 \leq i + j + k \leq m} {c}_{i , j , k} {x}^{i} {y}^{j} {z}^{k}$$

degree m.

By a Bernstein polynomial of total degree m in barycentric coordinates over a tetrahedron with corners P₁, P₂, P₃, P₄

$${q}_{m} ( {β}_{1} , {β}_{2} , {β}_{3} , {β}_{4} ) = {\sum }_{{i}_{1} + {i}_{2} + {i}_{3} + {i}_{4} = m} {c}_{i , j , k} {β}_{1}^{{i}_{1}} {β}_{21}^{{i}_{2}} {β}_{3}^{{i}_{3}} {β}_{4}^{{i}_{4}} .$$

The part of the polynomial inside the tetrahedron satisfies β₁, β₂, β₃, β₄≧0 with β₁+β₂+β₃+β₄=1. The Cartesian coordinates of a point P=(x, y, z) represented in barycentric coordinates are calculated by P=β₁+P₁+β₂P₂+β₃P₃+β₄P₄.
By a structure of tetrahedrons each containing a Bernstein polynomial in barycentric coordinates.
By a tri-variate tensor product polynomial in the power basis

$${q}_{{n}_{1} , {n}_{2} , {n}_{3}} ( x , y , z ) = {{\sum }_{i = 0}}^{{n}_{1}} {\sum }_{j = 0}^{{n}_{2}} {\sum }_{k = 0}^{{n}_{3}} {c}_{i , j , k} {x}^{i} {y}^{j} {z}^{k} of degrees {n}_{1} , {n}_{2} , {n}_{3} .$$

By a tri-variate tensor product polynomial in the Bernstein basis

$${q}_{{n}_{1} , {n}_{2} , {n}_{3}} ( x , y , z ) = {{\sum }_{i = 0}}^{{n}_{1}} {\sum }_{j = 0}^{{n}_{2}} {\sum }_{k = 0}^{{n}_{3}} {c}_{i , j , k} ( \begin{matrix}{n}_{1} \\ i\end{matrix} ) ( \begin{matrix}{n}_{2} \\ j\end{matrix} ) ( \begin{matrix}{n}_{3} \\ k\end{matrix} ) {{x}^{i} ( 1 - x )}^{{n}_{1} - i} {{y}^{j} ( 1 - y )}^{{n}_{2} - j} {{z}^{k} ( 1 - z )}^{{n}_{3} - k}$$

of degrees n₁, n₂, n₃.

By a tri-variate tensor product B-spline volume of degrees n₁, n₂, n₃.

$${q}_{{n}_{1} , {n}_{2} , {n}_{3}} ( x , y , z ) = {{\sum }_{i = 0}}^{{N}_{1}} {\sum }_{j = 0}^{{N}_{2}} {\sum }_{k = 0}^{{N}_{3}} {c}_{i , j , k} {B}_{i , {n}_{1}} ( x ) {B}_{j , {n}_{2}} ( y ) {B}_{k , {n}_{3}} ( z ) ,$$

where B_{i,n}_{₁}(x), i=1, . . . , N₁ B_{j,n}_{₂}(y), j=1, . . . , N₂ and B_{k,n}_{₃}(z), k 1, . . . , Nₖ are univariate B-spline bases respectively of degree n₁, n₂, n₃.
Rational versions of the above representations.
By a tri-directional grid of points. Such a grid can be visualized using marching cube approaches. However, it can readily be regarded as the control grid of a tri-linear B-spline volume or as the control polygon of a trivariate B-spline volume of degrees n₁, n₂, n₃.

The power basis represented polynomial qₘ(x, y, z) of total degree m can be converted to a Bernstein polynomial of total degree m and visa versa. The grid representation can be interpreted as a tri-variate B-spline, the tri-variate B-spline can be converted to a structure of tri-variate Bezier basis represented volumes. A Bezier represented volume of degrees n₁, n₂, n₃ can be converted to a Bernstein basis represented polynomial of total degree n₁+n₂+n₃ over a tetrahedron, or to a power basis representation.

Consequently the invention is valid for a wide variate of scalar field representations.

It also includes rational variants of the representations above.

To illustrate the principles of the approach we give some examples.

### Example

### Invention Used for the Visualization of Algebraic Surface or Scalar Field Describe by One Polynomial Equation

Assume that the scalar field/algebraic surface is represented by a Bernstein polynomial of total degree m in barycentric coordinates over a tetrahedron with corners P₁, P₂, P₃, P₄. Assume that the constant level we want to visualize has value c. For an algebraic surface c≡0. Consequently we can focus on the algebraic surface qₘ(β₁, β₂, β₃, β₄)=c=0. The tetrahedron can be used as the volume V describing the portion of the surface that we are interested in. However, the volume V can also be independent of the description of the tetrahedron e.g. a sphere.

From each pixel to be found in the image we intersect the corresponding projection ray with the view volume to find the actual line segment to be intersected with the scalar field, FIGS. 1, 2 and 3 the points P₀ and P₁. The parametric description of the line segment is inserted in the equation of the algebraic surface qₘ(β₁, β₂, β₃, β₄)−c=0 to produce the polynomial, FIG. 3 (313), used for determining the intersection of the rays with the selected level set of the scalar field/algebraic surface, FIG. 3 (f=c).

In the case where the scalar field/algebraic surface is describe in a tri-variate tensor product rational Bernstein basis we address the intersection of qₙ_{₁}_{,n}_{₂}_{,n}_{₃}(x, y, z)−c=0 and line segments above.

Other representations of an algebraic surface can be converted to these formats.

### Example

### Invention Used for the Visualization of Level Sets of a Scalar Field Represented by Tri-Variate Rational Tensor Product B-Splines

A typical visualization process will have multiple stages:
In the general case the tri-variate rational B-spline will consist of M₁×M₂×M₃ volume elements with at least one of M₁, M₂, M₃ greater than
   1. Consequently we should first detect which of the volume elements intersect the view volume V.

Each of the visible volume elements can then be treated as a scalar field represented by one rational function. However, the ray has to be clipped both by the view volume and the boundaries of the volume element.

### Example

### Invention Used for the Visualization of Level Sets by a Scalar Field Represented by a Point Grid

The point grid is regarded as the control polygon of a tri-linear B-spline surface and visualized with the approach described for tri-variate rational tensor product B-splines.

### Example

### Invention Used for Generating Raster Data and Visualization of Scalar Field Level Set Trimmed by a Set of Other Scalar Fields

In addition to the scalar field level set qₘ(β₁, β₂, β₃, β₄)=c, a set of other scalar fields are given tᵢ(β₁, β₂, β₃, β₄)=0, i=1, . . . , M. The only subset of qₘ(β₁, β₂, β₃, β₄)=c we are interested in is described by points satisfying tₗ(β₁, β₂, β₃, β₄)≧0, i=1, . . . , M. The algorithmic addition to the examples above is that points found in the ray level set intersection are discarded if the point satisfies tₗ(β₁, β₂, β₃, β₄)<0 for any i=1, . . . , M. In this case the search for intersection points has to continue further along the ray. The trimming test can be performed as part of the algorithm running on the SPU.

### Example

### Invention Used in Constructive Solid Geometry (CSG)

If the approach of constructive solid geometry (CSG) is used for describing volume objects, algebraic or piecewise algebraic surfaces are used for describing the half-spaces defining the extent of the volume. For each piece of an implicit surface that is part of the surface of the volume object, the adjacent (immediate neighboring) implicit surfaces take on the role as trimming surfaces. Consequently this example shows how the invention can be used for generating raster data and visualization of volumes described by constructive solid geometry.

### Use of the Approach for Scalar Field Volume Visualization

Volume visualization of scalar fields is frequently used within medicine, oil & gas industry and for the interpretation of simulation results.

In addition to the scalar field we assume that a transparency field a from Rⁿ to R is given where the values of α all are in [0,1], e.g., all are greater or equal to zero or less or equal to 1. The value zero means that the scalar field is transparent; the value 1 means that the scalar field is opaque.

In iso-surface visualization to find each of the n×m raster data we intersect the infinite straight line with the iso-surface and select the point inside the volume V closest to the centre of projection in the volume. For scalar field volume visualization we rather calculate the raster data produced by exact integration, numeric integration or sampling by combining the scalar field values and transparency values.

Let the [a,b] be the interval on the straight line l(t) within the volume V, with a representing the end closest to the centre of projection. Let f(t) be scalar field values along the straight line and a(t) be the corresponding transparency values. Let the function h: R to R^{l} l>0, express how we assign a visual appearance to the scalar field. Then one alternative for calculating the value of the raster data corresponding to the straight line is to use an integrator unit—a program running on a processor using analytical formulas for calculating integrals of functions—to calculate the integral

$${\int }_{a}^{b} α ( t ) h ( f ( t ) ) ( {\int }_{a}^{t} ( 1 - α ( s ) ) d s ) d t .$$

Here the integral

$${\int }_{a}^{t} ( 1 - α ( s ) ) d s$$

expresses how visible the point l(t) is seen from the centre of projection. The value α(t)h(ƒ(t)) expresses the visual contribution of the point l(t). If exact integration is not feasible, then a numerical integrator unit—a program running on a processor using numerical integration methods for calculating the integrals of functions—can be used.

The approach is not limited to only the above integral calculation.

### Use of the Approach for Combined Scalar Field Iso-Surface and Volume Visualization

The approach opens up for combining the use of iso-surface and volume visualization. One approach for doing this is first to calculate the iso-surface visualization taking care to remember the location b on each straight line representing the identified iso-surface point (FIGS. 1, 2 and 3) of the iso-surface. The combined isosurface and volume visualization can be expressed

$${\int }_{a}^{b} α ( t ) h ( f ( t ) ) ( {\int }_{a}^{t} ( 1 - α ( s ) ) d s ) d t + g ( b ) ( {\int }_{a}^{b} ( 1 - α ( s ) ) d s ) .$$

Here g(b) is the raster data calculated by the iso-surface visualization, and the integral

$$( {\int }_{a}^{b} ( 1 - α ( s ) ) d s )$$

tell show much the iso-surface visualization is obscured by the volume visualization. The raster data f(t) of the scalar field is converted to the same representation as g(b) by the function h(f(t)).

1. Computer apparatus for creating at least one set of raster data from a time varying or constant scalar field or vector field within a volume, said scalar or vector field being described using any of polynomial, rational, piecewise polynomial and piecewise rational representation, said computer apparatus comprising at least one central processor unit (CPU) operative to control a raster data algorithm, initialize sub-algorithms thereof, control said sub-algorithms and to control the use of the results of the calculations involving said sub-algorithms, characterized in that said computer apparatus further comprises at least one stream processor unit (SPU) operative to receive sub-algorithms of said raster data algorithm from said at least one CPU and to execute said sub-algorithms of said raster data algorithm, resulting in raster data, and operative to at least one of
return said raster data to said at least one CPU,
use said raster data as input to other sub-algorithms run on the at least one SPU, and
supply said raster data to other processors controlled by the at least one CPU.

2. Computer apparatus according to claim 1,
characterized in that said at least one central processing unit has multiple computation cores.

3. Computer apparatus according to claim 1,
characterized in that said scalar or vector field is trimmed by a number of other constant or time varying scalar fields.

4. Computer apparatus according to claim 1,
characterized in that said at least one SPU is constituted by at least one graphics processor unit (GPU).

5. Computer apparatus according to claim 1,
characterized in that said SPU comprises a sampler unit for generating said at least one set of raster data by sampling at least one level set of said scalar field or vector field.

6. Computer apparatus according to claim 1,
characterized in that said SPU comprises an integrator unit for generating said at least one set of raster data by integration of sub-sets of said scalar field or vector field.

7. Computer apparatus according to claim 6,
characterized in that said integrator unit is operative to perform said integration of sub-sets in combination with information from other scalar fields or vector fields such as transparency information.

8. Computer apparatus according to claim 7,
characterized in that said integrator unit is operative to generate at least one set of raster data by sampling at least one level set of said scalar field or vector field, and integrating said sub-sets of said scalar field or vector field.

9. Computer apparatus according to claim 1,
characterized in that said SPU comprises a numerical integrator unit for generating said at least one set of raster data by numerical integration of sub-sets of said scalar field or vector field.

10. Computer apparatus according to claim 9,
characterized in that said numerical integrator unit is operative to perform said integration of sub-sets in combination with information from other scalar fields or vector fields such as transparency information.

11. Computer apparatus according to claim 10,
characterized in that said numerical integrator unit is operative to generate at least one set of raster data by sampling at least one level set of said scalar field or vector field, and integrating said sub-sets of said scalar field or vector field.

12. Computer apparatus according to claim 1,
characterized in that said SPU is operative to produce one set of raster data, said one set of raster data representing an image of the scalar field or vector field.

13. Computer apparatus according to claim 1,
characterized in that said SPU is operative to produce two sets of raster data, said two sets of raster data representing a stereographic image of the scalar field or vector field.

14. Computer apparatus according to claim 1,
characterized in that said SPU is operative to produce at least one set of raster data, each set representing a description of the structure and geometry of a scalar field or vector field relative to a rectangular region of a plane.

15. Computer apparatus according to claim 14,
characterized in that the planes and the rectangular regions of the planes are the faces of a box where the faces are orthogonal.

16. Computer apparatus according to claim 15,
characterized in that said SPU is operative to produce only raster data from three orthogonal faces of the box.

17. Computer apparatus according to claim 16,
characterized in that the raster data represent points on a level set of the scalar field or vector field.

18. Computer apparatus according to claim 16,
characterized in that the raster data represent points on a level set of the scalar field and corresponding scalar field gradients.

19. Computer apparatus according to claim 17,
characterized in that said at least one SPU is operable to process said raster data from said three orthogonal faces of the box by any one of the following steps
transferring said raster data to said at least one CPU,
keeping said raster data on the at least one SPU, or
transferring said raster data to other processors for building a description of the level set.

20. Computer apparatus according to claim 14,
characterized by being adapted to use said raster data for segmentation of the scalar field or vector field.

21. Computer apparatus according to claim 12,
characterized by a frame buffer for receiving said raster data representing an image for the purpose of visualization.

22. Computer apparatus according to claim 13,
characterized by two frame buffers for receiving said raster data representing an stereographic image for the purpose of visualization.

23. Method to create at least one set of raster data from a time varying or constant scalar field or vector field within a volume, said scalar or vector field being described using any of polynomial, rational, piecewise polynomial and piecewise rational representation, said method comprising at least controlling execution of a raster data algorithm, initializing sub-algorithms thereof, controlling said sub-algorithms and controlling the use of the results of the calculations involving said sub-algorithms,
characterized in that said method further comprises controlling at least one stream processor unit (SPU) operative to receive sub-algorithms of said raster data algorithm and to execute said sub-algorithms of said raster data algorithm, resulting in raster data.

24. Method according to claim 23,
Characterized in that said raster data is
forwarded to at least one CPU,
used as input to other sub-algorithms run on the at least one SPU, or
supplied to other processors controlled by the at least one CPU.

25. Method according to claim 24,
characterized in that said scalar or vector field is trimmed by a number of other constant or time varying scalar fields.

26. Method according to claim 23,
characterized in that said SPU generates said at least one set of raster data by sampling at least one level set of said scalar field or vector field.

27. Method according to claim 23,
characterized in that said SPU generates said at least one set of raster data by integrating sub-sets of said scalar field or vector field.

28. Method according to claim 27,
characterized in that said integration of sub-sets is performed in combination with information from other scalar fields or vector fields such as transparency information.

29. Method according to claim 28,
characterized in that at least one set of raster data is generated by sampling at least one level set of said scalar field or vector field, and integrating said sub-sets of said scalar field or vector field.

30. Method according to claim 23,
characterized in that said at least one set of raster data is generated by numerical integration of sub-sets of said scalar field or vector field.

31. Method according to claim 30,
characterized in that said integration of sub-sets is done by numerical integration in combination with information from other scalar fields or vector fields such as transparency information.

32. Method according to claim 31,
characterized in that at least one set of raster data is generated by sampling at least one level set of said scalar field or vector field, and numerical integrating said sub-sets of said scalar field or vector field.

33. Method according to claim 23,
characterized in that one set of raster data is produced, said one set of raster data representing an image of the scalar field or vector field.

34. Method according to claim 23,
characterized in that two sets of raster data are produced, said two sets of raster data representing a stereographic image of the scalar field or vector field.

35. Method according to claim 23,
characterized in that said SPU is at least one set of raster data is produced, each representing a description of the structure and geometry of a scalar field or vector field relative to a rectangular region of a plane.

36. Method according to claim 35,
characterized in that the planes and the rectangular regions of the planes are the faces of a box where the faces are orthogonal.

37. Method according to claim 36,
characterized in that only raster data from three orthogonal faces of the box are produced.

38. Method according to claim 37,
characterized in that the raster data represent points on a level set of the scalar field or vector field.

39. Method according to claim 37,
characterized in that the raster data represent points on a level set of the scalar field and corresponding scalar field gradients.

40. Method according to claim 38,
characterized in that said raster data are processed from said three orthogonal faces of the box by any one of the following steps
transferring said raster data to said at least one CPU,
keeping said raster data on the at least one SPU, or
transferring said raster data to other processors for building a description of the level set.

41. Method according to claim 35,
characterized in that said raster data is used for segmentation of the scalar field or vector field.

42. Method according to claim 33,
characterized in that said raster data representing an image is stored in a frame buffer for the purpose of visualization.

43. Method according to claim 34,
characterized in that said raster data representing an stereographic image is stored in two frame buffers for the purpose of visualization.
